(19) United States
(12) Patent Application Publication
(10) Pub. No.: US 2025/0270067 A1
(43) Pub. Date: Aug. 28, 2025

(54) WINDING UNIT FOR A CABLE

(71) Applicant: Günther DOPPLER, Klosterneuburg (AT)

(72) Inventor: Günther DOPPLER, Klosterneuburg (AT)

(21) Appl. No.: 18/857,859

(22) PCT Filed: Apr. 6, 2023
(86) PCT No.: PCT/EP2023/059230

§ 371 Date: Oct. 18, 2024

(30) Foreign Application Priority Data
Apr. 19, 2022 (DE) 10 2022 109 465.0

(51) Int. Cl. B65H 75/44; H02G 11/02

(52) U.S. Cl. CPC B65H 75/4486; B65H 75/4415; H02G 11/02; B65H 2701/34

(57) ABSTRACT

A winding unit for a vehicle charging cable includes a rotationally symmetrical winding element, a rotationally symmetrical inner body, and a rotationally symmetrical outlet disc. The winding element has a first winding area, onto which a cable can be wound, and a second winding area in a radial peripheral area of the winding unit. The second winding area is arranged adjacent to the first winding area, so that a cable can be wound in the second winding area from an area close to the first winding area one above the other in the direction of the outlet disc in the opposite direction to a winding direction in the first winding area. In addition, the outlet disc can be rotated a predetermined number of revolutions together with the winding element and can then be blocked so that a cable is pushed out of the outlet opening.

### BACKGROUND

Exemplary embodiments of the invention relate to a cable reel and, in particular, to a winding unit for a cable which can be used, for example, for charging a vehicle.

Increasing electromobility places very special demands on the necessary infrastructure. This applies not only to a sufficiently high number of charging stations, which must be connected to a sufficiently dimensioned energy grid, but also to everyday and practical issues, such as the handling of individual charging cables for individual vehicles.

As a rule, manufacturers supply charging cables together with the vehicles for this purpose, which can be stored loosely folded up in the trunk, in your own garage, or in other storage spaces in the vehicle. When the charging cable is then taken out to charge the vehicle at a public charging point, it is connected to the vehicle on one side—respectively to the plug provided thereon—and to the charging station on the other. A large part of the cable lays then usually on the ground, i.e., on the street, the sidewalk, a parking lot and, in the best case, on the garage floor. Especially in bad weather situations, rain, snow or mud, the cable gets wet and dirty and then has to be wound up by hand after charging. This is not only unpleasant but also questionable from a hygiene point of view, as there is a potentially high risk of soiling your own clothes or hands. Manufacturers have not yet come up with a really practical solution for such impractical handling of charging cables that is suitable for everyday use.

There is a whole range of cable drums that are suitable for winding electrical cables. For example, the document DE 10 2009 046 327 A1 describes a device for the electrical connection of an electric vehicle to a power outlet. It also mentions a cable on a winding device that is driven by two gear wheels. One side of the cable is wound up in the usual way as in a normal cable drum in a comparatively wide area, while the other end emerges from a central area of the cable drum. This results in a number of problems, particularly with regard to current path guidance. As the long end of the cable rotates the cable drum during unwinding or winding, special attention must be paid to the transition (element) to a non-rotating part—i.e., the part of the cable that exits at a central point. As a rule, only sliding contacts can be considered for this purpose. However, the electrical power to be transmitted, which is required to charge an electric vehicle, results in a whole series of problems with energy transmission via sliding contacts.

Another solution is described in the document DE 10 2011 080 085 A1. This application also relates to a cable drum, in particular for an electric vehicle, whereby the cable can be wound around a winding core or unwound accordingly. This avoids sliding contacts and the cable can be held in one piece in the cable drum. However, according to this document, it is also envisaged that part of the cable emerges from the central area of the cable drum. This can therefore not be used for an axle and storage of the heavy cable drum. In addition, it is necessary for the inner part and the outer part of the cable winding to lie on top of each other, which makes the geometric dimensions of the cable drum very large and uses up a lot of the limited storage space available in a vehicle.

There is therefore a need for a device for winding and stowing charging cables for electric vehicles, which overcomes the known disadvantages of the traditionally used technology, is compact and also enables further improvements in daily use.

This invention is therefore based on the task of presenting a winding device which is not burdened by the disadvantages of the previous charging cables for electric vehicles and in particular has an easy-to-handle design suitable for everyday use.

### SUMMARY OF THE INVENTION

The above-mentioned problem is solved by the subject-matter of the independent patent claims. Advantageous embodiments of the present invention are described by the dependent claims.

According to one aspect of the present invention, a winding unit for a cable is presented. It can be suitable for charging an electric vehicle. The winding unit has a rotationally symmetrical winding element that is mounted so it can rotate about an axis. In addition, there is a rotationally symmetrical inner body that is firmly connected to the axis. Furthermore, a rotationally symmetrical outlet disc is provided that is mounted so it can rotate about the axis. The winding unit has a first winding region of a first width, so that a cable can be wound up one above the other in the first winding region from an area close to the axis. The winding element also has a second winding region in a radial peripheral region of the winding element, the second winding region being arranged adjacent to the first winding region and having a second width, so that a cable can be wound up one above the other in the second winding region opposite to a winding direction in the first winding region.

The outlet disc can be rotated by a predetermined number of revolutions together with the winding element and can then be blocked so that a cable can be pushed out of an outlet opening in a radially peripheral region of the outlet disc at the level of the second winding region as a result of further rotation of the winding element.

The cable drum presented has a number of technical effects, advantages, and improvements: Compared to traditional cable drums, both the long part of the cable on one side of the winding element and the other, short part of the cable can be individually configured and are in no way dependent on the length of the other side of the cable. This is achieved by the special design inside the winding unit and the cable guide.

Because the rotationally symmetrical outlet disc can partially rotate freely together with the winding element, but can also be blocked after a certain number of rotations (or parts thereof) of the winding element, both units—in particular the winding element and the outlet disc—can partially rotate together and partially not rotate together. In this way, it can be achieved that one end of the cable is pushed out of an opening in the outlet disc. This is usually the shorter part of the cable. It should also be noted that the cable does not have to be pushed out of the outlet disc in a central area, but rather in a peripheral area of the same.

This can be achieved by designing the two winding areas provided inside the winding element differently. The second winding area is located in a peripheral area of the winding element adjacent to the outlet disc. A connection between the first and second winding areas is achieved by a cable transition element from the first winding area to the second winding area. The cable transition element is guided inside the winding element between the first winding area and the inner body. In addition, the two ends of the cable are wound in opposite directions in the winding element.

An operator can now unwind the long end of the cable from the first winding area by simply pulling the cable; alternatively, the optionally available motor drive can be used. The outlet disc rotates together with the winding element until a predetermined number of revolutions (or parts thereof) is reached. The outlet disc is then blocked—in particular, relative to a stationary part such as a housing of the winding unit, relative to which the winding element continues to rotate—so that the typically shorter cable end is automatically pushed out of the outlet opening of the outlet disc. The opening provided in the outlet disc in the second winding area extends over the entire height of the radially superimposed windings of the cable. The cable can exit the outlet disc in a controlled manner via a guiding element. An orderly winding and unwinding of the cable in the second winding area can be ensured by a helical guiding structure in the second winding area, so that the cable is safely guided radially in the second winding area. This allows the cable to be pushed out in a deliberate and controlled manner. The second end of the cable is therefore automatically made available to the user.

Because a drive—for example an electric drive—can be located inside the winding unit, in a first winding phase both, the short end is wound up in the second winding area while the outlet disc does not rotate together with the winding element, and the long end is wound up in the first winding area.

In a second winding phase—especially after the short end of the cable has already been wound up—the outlet disc rotates together with the winding element, whereby the long end of the cable is now completely wound up in the first winding area. This means that both cable ends are optimally and automatically wound up, by the electric drive inside the winding unit.

In addition, all elements of the winding unit can be integrated into a housing, resulting in an overall very compact unit that can be easily stored in a vehicle or at another location. The proposed winding unit can therefore be operated in both ways, stationary and mobile.

In addition, it is easily possible to provide a cleaning unit for the cable both, at the outlet opening and in the area where the long cable end enters the first winding area. In this way, it is possible for the cable to always be wound up in the winding unit in a clean state without a user having to touch or clean the cable by hand. The user only has to pull the plugs out of both the vehicle and the charging unit and place them on the floor. The winding can be carried out completely autonomously by the winding unit after the winding process has been triggered, for example electrically.

Because the outlet disc can be blocked after a configurable number of revolutions, it can also be ensured that the cable is almost completely unwound from the winding area 1 before the cable can be pushed out of the winding area 2. This means that the cable can only be connected when the entire length has been unwound. Thermal overload of the cable can thus be specifically prevented.

The optional motor drive offers the advantage that the cable drum does not have to be raised and held at “belly height”, as is practical for a manual “crank operation”. Instead, the winding process can be achieved automatically with little effort on the outstretched arm.

Furthermore, by installing all electrical/electronic components in the static inner body, very good protection against damage caused by dirt, especially water, can be ensured. It should also be mentioned that the winding unit can be made very compact despite its elegant function, so that the cable can be wound in layers on top of each other in both, the first and second winding area, when viewed from the axis.

In the subsequent paragraphs, further embodiments of the winding unit are described:

According to an extended embodiment of the winding unit, a cable having a cable diameter can be present that extends from the first winding area between this and the inner body into the second winding area and out of the outlet opening. The cable ends can be equipped with plugs. The presence of the cable makes the winding unit ready for practical use. Because the cable can be inserted into the winding unit or the two winding areas through slots provided for this purpose, the winding unit and the cable can be purchased from different sources. In addition, an existing cable can be made more manageable and upgraded by the winding unit. It is assumed that the winding unit does not have to be delivered together with the cable. Existing charging cables for electric vehicles can therefore also be retrofitted with the winding unit.

According to an extended embodiment of the winding unit, the cable can be wound in a wound state with a first section in the first winding area and wound with its second section in the opposite direction onto the second winding area. It must be taken into account that a third short section (i.e., a transition element which can be located below the second winding area) is located between the first section and the second section of the cable inside the winding unit and here the cable winding direction is reversed.

According to an advantageous embodiment of the winding unit, the first section can be longer than the second section. In this way, for example, the winding unit can be located directly next to the vehicle or the charging socket of the vehicle, while the long end of the cable can be connected to the charging station or the charging point at a more distant location.

According to a further embodiment of the winding unit, the first width—in particular of the first winding area—can correspond to the cable diameter plus a tolerance width that is smaller than the cable width. This ensures that the cable can be wound up layer by layer into the first winding area without becoming jammed in the first winding area. The turns of the cable then lie essentially on top of one another.

According to an alternative embodiment of the winding unit, the first width —in particular of the first winding area—can be wider than the cable diameter. In this case, the cable can also be wound up in several cable widths next to each other in the first winding area and only then move on to the next winding level. Advantageously, however, the winding unit would not be more than 2 to 3 cable widths wide in order to enable the cable to be wound up in an orderly manner. The cable windings then lie both next to each other and on top of each other. In this way, despite the compact design, a longer cable section can be wound up in the first winding area. This means that charging points that are a little further away can also be reached.

According to a useful embodiment of the winding unit, the second width—in particular of the second winding area, can correspond at least to the cable diameter. The second width should also not be much wider than the cable thickness, so that the cable in the second winding area is forced—with a corresponding length—to lie one on top of the other (from an axial perspective) due to the spiral guide. The width or thickness of the helical guide must also be taken into account.

According to a further advantageous embodiment of the winding unit, the cable can be designed for a power output of at least 11 KW. In addition, a design for a higher charging or power output is possible. This means that different standards for electrical cables for charging electric vehicles can be wound up with the proposed winding unit.

According to an extended embodiment of the winding unit, the cable diameter can be at least 11 mm or more, in particular 13 mm. In addition, single-phase cables with three conductors or 3-phase cables with, for example, five conductors can be used.

According to a particularly advantageous embodiment of the winding unit, the winding unit can be rotatably mounted on the first region of the inner body. This part of the inner body thus becomes a bearing or rotating region for the winding element. Typically, the inner body is firmly connected to a housing.

Therefore, and according to a further embodiment of the winding unit, the inner body can be hollow and have a rotation drive unit for the winding unit. In this way, the winding unit can be driven without manual effort. For this purpose, an electric motor and a power supply—for example a battery or a power pack—as well as an electric and/or electronic control unit can be located inside the inner body.

Accordingly, and according to a further embodiment of the winding unit, the rotation drive unit may comprise the electric motor which drives the winding element relative to the inner body.

Advantageously, according to a supplementary embodiment of the winding unit, the motor can be switched from outside the inner body. This can be done, for example, by a switch on the housing of the winding unit, a key switch or similar. A key switch can also ensure that unauthorized persons cannot start the drive.

Furthermore, according to an additional embodiment of the winding unit, the motor can be remotely controlled. This can be done via a radio remote control, via an NFC connection (Near Field Communication), a Bluetooth connection, WLAN, or similar.

According to a further elegant embodiment of the winding unit, a locking unit between the outlet disc and/or the winding element and/or the inner body can be triggered electromagnetically from the inner body. In this way, the outlet disc can be fixed relative to the inner body or the housing after the preconfigured number of revolutions, so that only the winding element can continue to rotate around the inner body, so that the typically short cable end is pushed out of the second winding area through the outlet opening.

Alternatively, the locking unit between the outlet disc and the winding element and/or the inner body can be triggered mechanically.

According to a further practical embodiment of the winding unit, a first cleaning unit can additionally be present in the area of the outlet opening and/or a second cleaning unit in the area of the first winding area. The cable would then run past or through these cleaning areas, whereby it would be cleaned. Therefore, there will always be a clean cable inside the winding unit. The cleaning unit can also be combined with the guiding frame.

Furthermore, according to an embodiment of the winding unit, it can be provided that the cable with mounted plugs at both ends can be inserted into the first winding area, between the first winding area and the inner body, into the second winding area and out of the outlet opening through respective slots in the winding element and the outlet disc. In this way, the winding unit and the cable could be obtained from different sources. An existing cable could also be connected to the proposed winding unit without one or both plugs having to be dismounted.

A supplementary embodiment of the winding unit can provide that a housing with openings for the two ends of the cable is additionally provided, which would at least enclose the winding unit. In addition, the housing could ensure that the winding unit stands securely on the floor.

A further advantageous embodiment of the winding unit can provide that the outlet opening in the outlet disc extends over an entire width of superimposed turns of the cable (from an axial viewing direction) in the second winding area. If you look through the outlet opening, the turns of the cable are shown lying next to each other. This can—in conjunction with a helical guide—ensure that the cable can be wound up and unwound without any problems in the second winding area and that no winding bottlenecks arise as with an opening that is too small.

It is also advantageous if a sliding unit can be located in or near the outlet opening. This allows the cable to be guided safely.

It should also be mentioned that according to a further embodiment of the winding unit, the sliding unit consists of at least one first roller. This can be located at the point where the cable penetrates the plane of the outlet disc through the opening in the outlet disc. An axis of the roller would thus be approximately perpendicular or exactly perpendicular to the axis of the winding unit and would be located in a lateral area of the outlet opening. A second roller can also be located on the opposite side of the outlet opening in relation to the first roller. The cable would therefore be guided through the second and first rollers on the upper and lower sides when outlet the outlet opening. Ideally, the roller extends over the entire height of the outlet opening in the outlet disc.

An alternative and advantageous embodiment of the winding unit has a guiding frame on an outside of the outlet disc in the area of the outlet opening, through which the cable extends. This also enables the cable to be guided cleanly when unwinding or winding from or into the second winding area. The guiding frame can also be designed in the form of the cleaning unit or combined with it.

It would also be advantageous if the guiding frame—according to a further embodiment—could be displaced in a slot in the outlet disc.

Another well-functioning embodiment of the winding unit can also provide that the second winding area has a helical guide in which the cable can be wound up. This helical guide proves to be advantageous in order to allow the cable in the second winding area to exit from the opening of the outlet disc in a targeted and controlled manner.

According to a further embodiment of the winding unit, it would be elegant if a guiding device of the guiding frame, which extends into the second winding region, moves the guiding frame through the helical guide in the slot during rotation of the second winding region.

Furthermore, according to a supplementary embodiment, the guiding frame can have at least a second roller. This ensures that the cable is guided cleanly. It has also proven to be advantageous if one or both rollers of the guiding frame have a concave cross-section along their respective longitudinal direction. This also benefits clear cable guidance.

In addition, the winding unit can also have a cover extending over the outlet opening and the guiding frame. Furthermore, the guiding frame can also be displaced in a controlled manner via an additional (upper) guide in the cover. This ensures protection for the outlet opening and for the guiding frame.

It is pointed out that embodiments of the invention have been described with reference to different subject-matters. In particular, some embodiments of the invention may have been described with device claims and other embodiments of the invention with method statements. However, it will immediately become clear to the person skilled in the art upon reading this application that, unless explicitly stated otherwise, in addition to a combination of features belonging to one type of subject-matter, any combination of features belonging to different types of subject-matter is also possible.

Further advantages and features of the present invention emerge from the following exemplary description of currently preferred embodiments. The individual figures of the drawings of this application are to be regarded as merely schematic and not to scale.

### BRIEF DESCRIPTION OF THE FIGURES

In the following, preferred embodiments are described by way of example and with reference to the following figures:

FIG. 1 shows an embodiment of the winding unit for a cable according to the invention in a sectional view.

FIG. 2a shows the outlet disc with the outlet opening and the guiding frame.

FIG. 2b shows the guiding frame in greater detail.

FIG. 3 shows different views of the second winding area (in cross section), the outlet disc with the outlet opening from the front and from above.

FIG. 4a shows the cable path in the second winding area.

FIG. 4b shows a sectional view of the cable exiting the outlet opening with the sliding mechanism.

FIG. 5a shows the helical guide for the cable in the second winding area.

FIG. 5b shows the helical guide for the cable in the winding area along the cutting plane shown in FIG. 5a.

FIG. 6 shows how the guiding frame is guided through the helical guide.

### DETAILED DESCRIPTION OF EMBODIMENTS

The following terms and expressions are used in this document:

The term “electric vehicle” describes any vehicle that is equipped with an electric drive. This includes electric cars, electric vans, electric motorcycles, electric scooters and also electric trucks, as well as electric boats, airplanes and electric rail vehicles. Other electrically powered vehicles are not excluded.

The term “inner body” describes a rotationally symmetrical body that is located inside the winding unit and is at least partially enclosed by the winding unit. The part of the inner body that has a smaller diameter can serve as a counter bearing for the winding element. Between the two there can be a ball bearing, a double ball bearing, a roller bearing, or a plain bearing. The inner body can be either solid or hollow. If it is a hollow inner body, it can be closed with covers on either one or both sides. In this way, maintenance work can easily be carried out, e.g., on the internal electric motor. The narrow part of the inner body can serve as the axis of rotation for the winding unit. The inner body can also have a pin in the middle of the wider side (for example) on the cover, so that it can also serve as an axis for the outlet disc. Other axis guides are conceivable—e.g., extending from a housing of the winding unit.

The term “winding unit” describes a substantially rotationally symmetrical element of the winding element, which has a first winding area and a second winding area. A cable can be guided to the second winding area through an opening in a side wall of the first winding area, which opening faces the inner body.

The term “outlet disc” describes a ring-shaped element with an outlet opening for the cable. The outlet disc should have a diameter that is at least the size of the second winding area of the winding unit plus, for example, twice the cable diameter. The outlet disc can also be designed as a circular disc or have a separable inner part that can be accommodated by an axis. In addition, the outlet disc can be blocked against rotation of the winding element. This can be done on the one hand by, for example, a blocking pin (which can also be inserted manually) or alternatively, for example, electromagnetically from the inner body. An electromagnet can advantageously actuate the locking unit.

The term “outlet opening” describes an opening in the outlet disc through which the cable can be pushed out. Typically, the pushing out will occur essentially in an almost tangential direction of a surface of the outlet disc.

The term “cable” describes an electrical multi-core cable which is intended for a power transmission of at least 11 kW or at least 16 A at 240 V. Such cables typically have a diameter of just under 1.5 cm (in particular 1.3 cm). However, the winding unit can also be designed for cables with smaller diameters and also much larger diameters.

The term “rotary drive unit” describes a substantially electrically operated unit—such as an electric motor with an associated battery that can supply the motor with electrical energy—so that the winding unit can be driven and rotated relative to the inner body.

The term “cleaning unit” describes a device near the outlet opening of the outlet disc, past which the cable can be guided or through. The cleaning unit consists, for example, of brushes and/or sponges to ensure that the cable is cleaned during winding. The cleaning unit can be provided either directly on the outlet disc or in a housing that encloses the winding unit. In addition, a cleaning unit can also be present in the first winding area. It can be combined with the guiding frame.

It is pointed out that features or components of different embodiments that are the same or at least functionally equivalent to the corresponding features or components of the embodiment are largely provided with the same reference numerals or with a different reference numeral that differs only in its first digit from the reference numeral of a (functionally) corresponding feature or a (functionally) corresponding component. To avoid unnecessary repetition, features or components that have already been explained using a previously described embodiment will not be explained in detail again.

It should also be noted that the embodiments described below represent only a limited selection of possible embodiment variants of the invention. In particular, it is possible to combine the features of individual embodiments with one another in a suitable manner, so that a large number of different embodiments can be regarded as obviously disclosed by the embodiment variants explicitly presented here for the person skilled in the art.

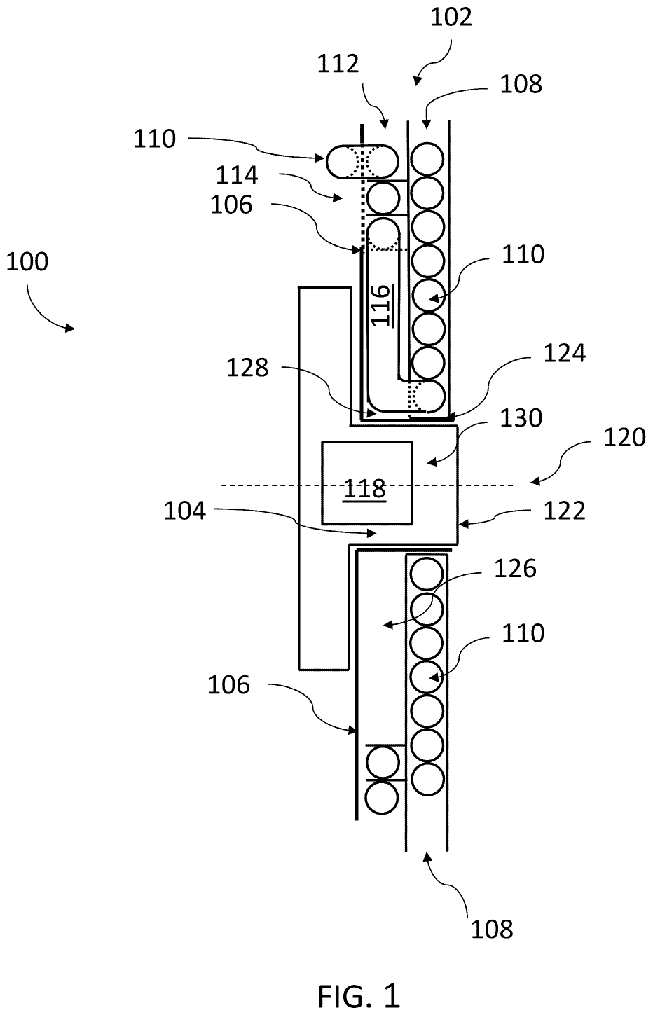

FIG. 1 shows an embodiment of the winding unit 100 according to the invention for a cable 110, e.g., for charging an electric vehicle, in a sectional view. The winding unit 100 has a rotationally symmetrical winding element 102 which is mounted so as to be rotatable about an axis (not shown), a rotationally symmetrical inner body 104 which is firmly connected to the axis, and a rotationally symmetrical outlet disc 106 mounted so as to be rotatable about the axis.

The winding element 102 comprise a first winding region 108 of a first width, so that a cable 110 can be wound up in the first winding region 108 from a region close to the axis one above the other. The winding element also has a second winding region 112 in a radial peripheral region of the winding element 102, wherein the second winding region 112 is arranged adjacent to the first winding region 108 and has a second width (e.g., the same or similar width as the first winding region), so that the cable 110 can be wound up (or unwound) in the second winding region 112 from a region closer to the axis one above the other in the direction of the radial periphery of the outlet disc 106 against a winding direction in the first winding region 108.

The outlet disc 106 rotates a predetermined number of revolutions (or fractions thereof) together with the winding element 102 and can then be blocked so that the cable 110 can be pushed out of the outlet opening 114 in a radially peripheral region of the outlet disc 106 at the level of the second winding region 112 as a result of further rotation of the winding element 102.

In addition, it is clearly visible in the cross-section through the winding unit 100 that the first winding area 108 shows the cable 110 wound in layers one above the other. In addition, one can see the inner body 104 and the outlet disc 106, from whose outlet opening 114 the cable 110 can emerge. In the figure, one can also see that the cable in the second winding area 112 is also wound one above the other if there are several turns. The cable 110 leaves the first winding area 108 in a lower area of the winding area 108—i.e., in the vicinity 128 of the narrower part 130 of the inner body 104 —in order to be guided into the second winding area 112 in a hollow space 126 between the first winding area 108 and the inner body 104 via a short connecting piece 116; within this, the cable is now wound in the opposite direction if compared to the first winding area.

An electric drive motor 118, a battery, a remote control receiver, and other control electronics (each not shown) can be accommodated inside the inner body 104. In addition, the electrics or electronics in the inner body 104 can be led out of the inner body 104 via a cable connection near the schematically shown axis 120, for example in the area 122 of the inner body 104. This applies both, to a charging current for the battery (not shown) and to necessary control signals. In addition, a bearing or plain bearing 124 is shown between the winding element 102 and the inner body 104.

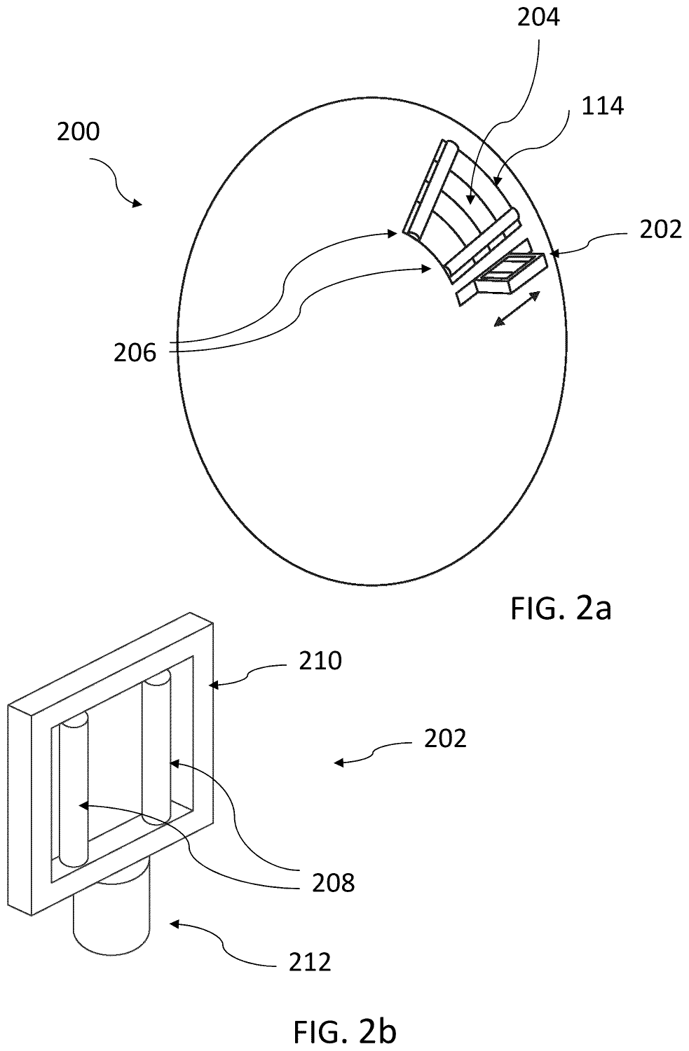

FIG. 2a shows a perspective view 200 of the outlet disc 106 with the outlet opening 114 and the guiding frame 202. The double arrow to the right of the guiding frame 202 is intended to symbolize that the guiding frame 202 can be moved radially. This can be supported or even made possible by the helical guide 204, which can be seen in the outlet opening 114. In addition, rollers 206 (e.g., as a realization of the sliding unit, alternatively, e.g., round edges of the outlet disc, Teflon coated, or similar) can be located on a left and right side of the outlet opening 114 in the outlet opening 114 over the entire height of the outlet opening 114, so that a cable exiting from the outlet opening 114 can be guided cleanly through the rollers 206 and additional rollers of the guiding frame 202.

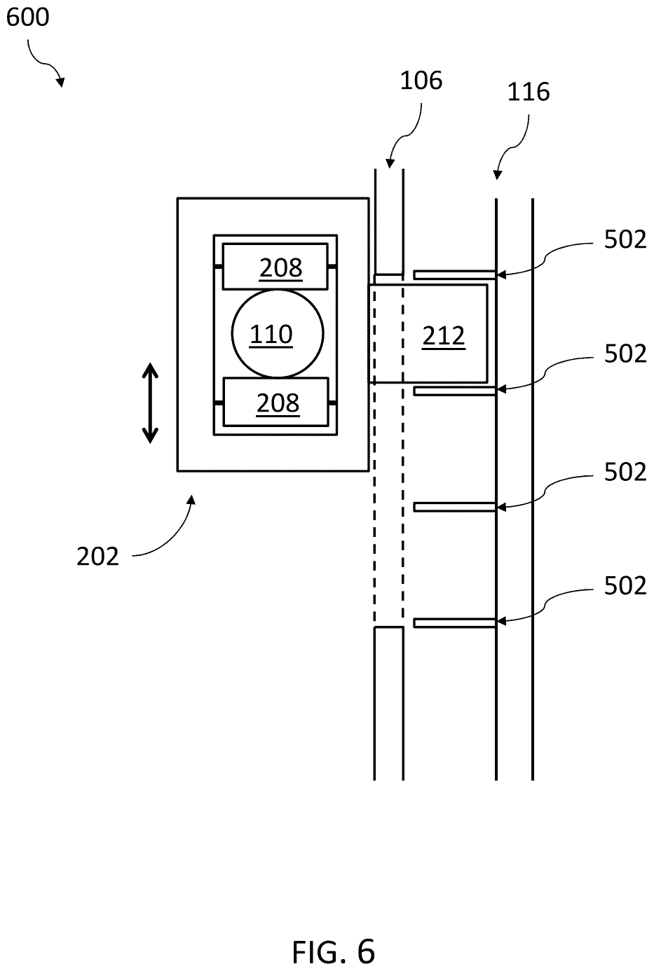

FIG. 2b shows the guiding frame 202 in greater detail. The rollers 208 can be rotatably mounted by the frame 210 by means of an axis (not shown). The cable can then be guided between the two rollers 208. In an advantageous embodiment, the rollers 208 can be designed concavely. In the lower part of the guiding frame 202 there is a further guide pin 212 which can engage in the helical guide of the second winding area (see FIG. 6) after it has pierced the outlet disc through a slot.

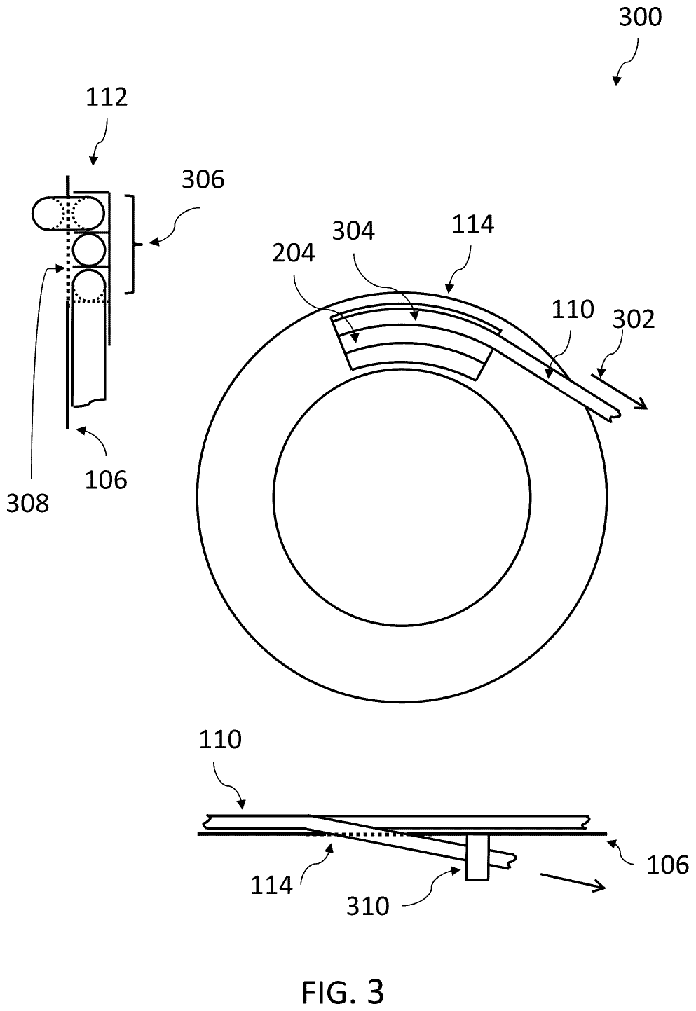

FIG. 3 shows various views 300 of the second winding area (in cross section), the outlet disc 106 with the outlet opening 114 from the front and from above (shown here without the rollers 206). The outlet disc 106 can be seen, from which the cable 110 can be pushed out in the direction of the arrow 302 or—in the opposite direction—pulled in again. The cable 110 is just being pushed out of the uppermost guide groove 304 of the helical guide 204. In the example shown, three windings are visibly provided in the second winding area. However, there can also be more or fewer. This may also depend on the cable thickness.

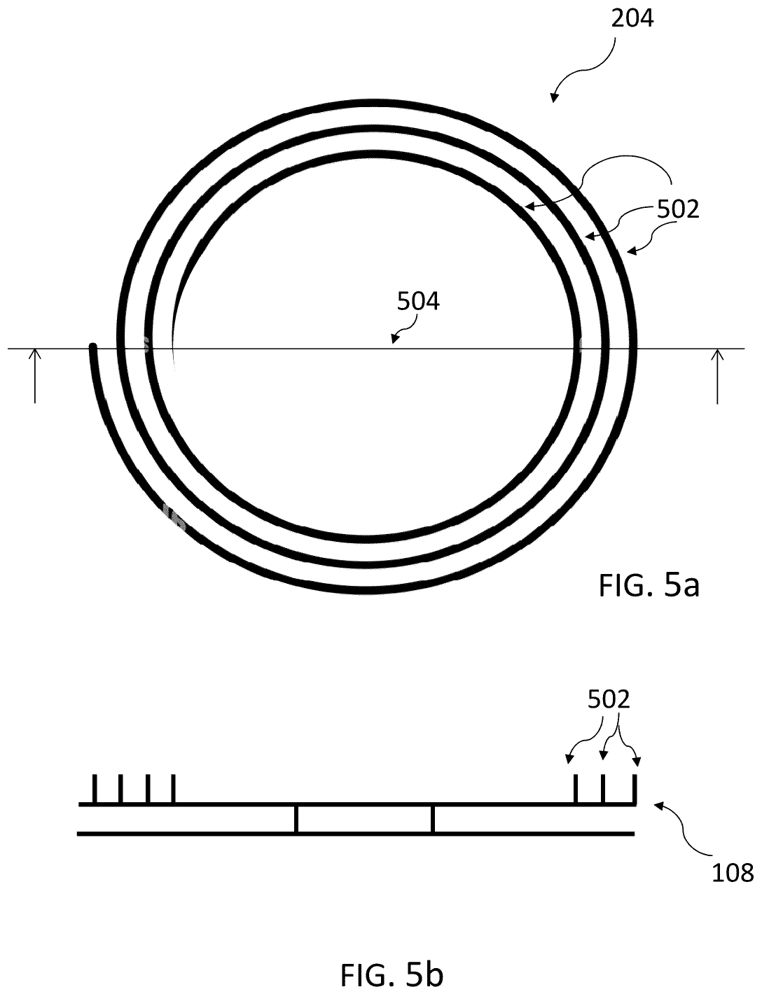

The partial figure at the top left again shows three superimposed windings 306 in the second winding area. The guide ridge 204 (or a helical continuous guide wall 502 or ridge, see FIG. 5) can be seen between the windings of the cable 110.

The lower part of FIG. 3 (section from above) shows how the cable 110 is pushed out of the outlet opening 114 from the second winding area of the outlet disc 106 (see arrow). It can be guided through a guide or the guiding frame 202 and/or alternatively through a cleaning unit 310 and/or the sliding unit 206 (not shown here).

It can also clearly be seen how the cable 110 can be pushed out of the outlet opening 114 in a quasi-tangential manner via the second winding area. The cleaning unit 310, through which the cable 110 can be guided, can ensure that there is always a cleaned cable 110 inside the winding unit.

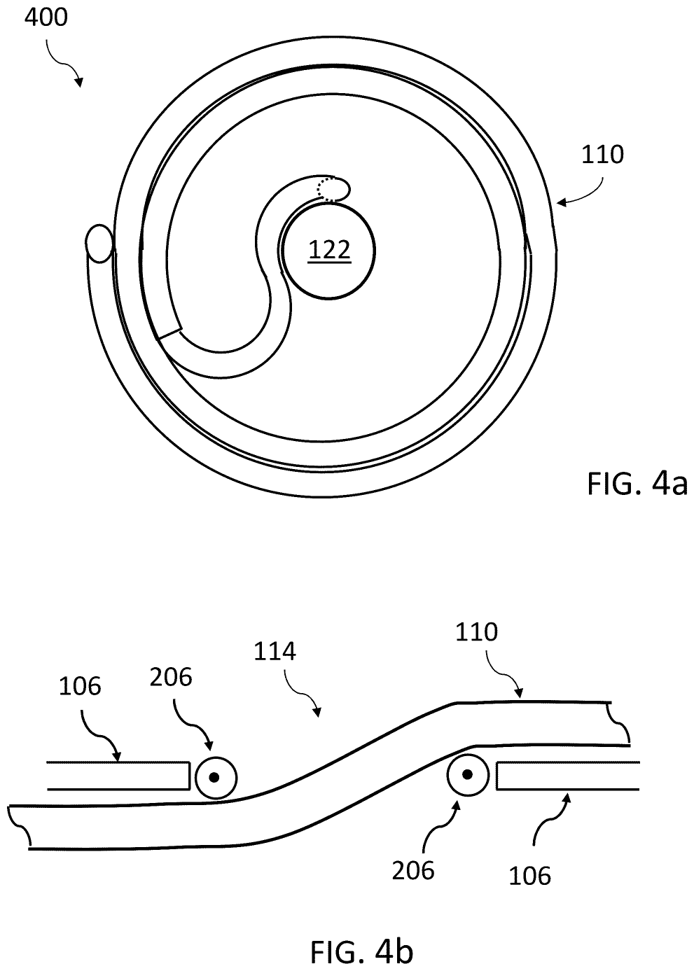

In FIG. 4a it is shown (400) how the cable 110 is guided from the first winding region in the vicinity 128 of the narrower part 122 of the inner body 104 in the region between the first winding region (not shown) and the second winding region, so that an opposite winding direction results in the first winding region and the second winding region.

FIG. 4b again shows a cross-sectional plan view of the cable entry through the area of the outlet opening 114 of the outlet disc 106. The rollers 206 in the side areas of the outlet opening 114, through which the cable 110 can be guided cleanly without rubbing against the opening edges of the outlet opening 114, can also be clearly seen.

FIG. 5a shows the guiding web (cf. 308, FIG. 3) or the wall 502 of the helical guide structure 204 for the cable 110 (not shown) in the second winding area in a plan view.

FIG. 5b shows a side sectional view of a sectional view of the helical guide structure 204 through the cutting plane 504 in the second winding area 108. Here, too, the walls 502 are clearly visible.

FIG. 6 shows a detailed view 600 of the guiding frame 202, which can be moved in the direction of the arrow in a surface of the outlet disc 106. The movement in the direction of the arrow is achieved by rotating the second winding area 112 relative to the outlet disc 106 and guiding the guide pin 212 of the guiding frame 202 through the continuous wall 502 of the helical guide. After a complete rotation of the second winding area 112, the guide pin 212 would have to be shown in the middle of the three areas of the helical guide 204. So that the sliding mechanism 202 with the guiding pin 212 does not fall out, an additional groove can be provided in the area of the guide pin 212, which slides in the outlet disc 106 (or similar).

It should also be noted that the cable 110 is only shown between the rollers of the guiding frame 202. A representation of the cable 110 in the helical guide has been omitted.

The description of the various embodiments of the present invention has been presented for better understanding, but does not serve to directly restrict the inventive idea to these embodiments. Further modifications and variations will be apparent to those skilled in the art. The terminology used here has been chosen to best describe the basic principles of the embodiments and to make them easily accessible to those skilled in the art.

The illustrated structures, materials, processes, and equivalents of all means and/or steps with associated functions in the claims below are intended to apply any structures, materials, or processes expressed by the claims.

In summary, a winding unit for a cable—essentially a cable drum—is presented, the outlet disc of which can be partially blocked from rotating with the winding unit, so that one end of the cable is pushed out of the outlet opening. The other end of the cable is simultaneously unwound from a first winding area of the winding unit. A respective cleaning unit in the area of the outlet openings, for example of a housing of the winding unit, ensures that only cleaned cable is wound up in the winding unit. The winding and unwinding can be performed electrically.

### REFERENCE NUMERALS

100 winding unit
102 winding element
104 inner body
106 outlet disc
108 first winding area
110 cable
112 second winding area
114 outlet opening
116 short connecting piece
118 drive motor
120 symbolic axis
122 narrow area of the inner body
124 bearing or plain bearing
126 hollow space between the first winding area 108 and the inner body
128 vicinity of the narrower part of the inner body
130 narrow part of the inner body
200 perspective view 200 of the outlet disc
202 guiding frame
204 helical guide
206 guiding-out unit/roller
208 roller of the plain bearing
210 frame
212 guiding pin
300 different views of the outlet disc
302 direction of outlet of the cable
304 uppermost guide groove
306 winding on top of each other
308 guiding ridge
310 cleaning unit
400 presentation of opposing windings of the cable
502 guiding ridge
504 cutting plane
600 Detail view of the guiding frame at the outlet disc

1-28. (canceled)

29. A winding unit for a cable, the winding unit comprising:
a rotationally symmetrical winding element mounted so that the rotationally symmetrical winding element is rotatable about an axis;
a rotationally symmetrical inner body firmly connected to the axis;
a rotationally symmetrical outlet disc mounted so the rotationally symmetrical outlet disc is rotatable about the axis;
wherein the rotationally symmetrical winding element has a first winding region of a first width so that the cable is windable, into the first winding region from a region close to the axis, one above the other,
wherein the rotationally symmetrical winding element has a second winding region in a radial peripheral region of the rotationally symmetrical winding element, wherein the second winding region is arranged adjacent to the first winding region and has a second width so that the cable is windable in the second winding region from a region close to the first winding region one above the other in an opposite direction to a winding direction in the first winding region,
wherein the rotationally symmetrical outlet disc is rotatable for a predetermined number of revolutions together with the rotationally symmetrical winding element and then is blocked so that the cable is pushed out of an outlet opening in a radially peripheral region of the rotationally symmetrical outlet disc at a level of the second winding region as a result of further rotation of the rotationally symmetrical winding element.

30. The winding unit of claim 29, further comprising:
the cable with a cable diameter extending from the first winding region between the cable and the inner body into the second winding region and out of the outlet opening.

31. The winding unit of claim 30, wherein the cable, in a wound state, is wound with a first portion in the first winding region and is wound with a second portion in the opposite direction on the second winding region.

32. The winding unit of claim 30, wherein the first portion is longer than the second portion.

33. The winding unit of claim 30, wherein the first width corresponds to the cable diameter plus a tolerance width, wherein the tolerance width is smaller than the cable diameter.

34. The winding unit of claim 30, wherein the first width is wider than the cable diameter.

35. The winding unit of claim 30, wherein the second width corresponds at least to the cable diameter.

36. The winding unit of claim 29, wherein the rotationally symmetrical winding element is rotatably mounted on a first region of the rotationally symmetrical inner body.

37. The winding unit of claim 29, wherein the rotationally symmetrical inner body is hollow and has a rotation drive unit configured to drive the winding unit, and wherein the rotation drive unit comprises a motor that drives the rotationally symmetrical winding element relative to the rotationally symmetrical inner body.

38. The winding unit of claim 37, wherein the rotationally symmetrical inner body houses a battery configured to supply power to the motor.

39. The winding unit of claim 37, wherein the motor is switchable from outside the rotationally symmetrical inner body or the motor is remotely controllable.

40. The winding unit of claim 37, further comprising:
a locking unit, wherein the locking unit is arranged between the rotationally symmetrical outlet disc and the rotationally symmetrical winding element or the locking unit is arranged between the rotationally symmetrical outlet disc and the rotationally symmetrical inner body,
wherein the locking unit is triggerable electromagnetically from inside of the rotationally symmetrical inner body or the locking unit is mechanically triggerable.

41. The winding unit of claim 29, further comprising:
a first cleaning unit in a region of the outlet opening, or
a second cleaning unit in a region of the first winding region.

42. The winding unit of claim 29, wherein a cable with mounted plugs at both ends is insertable into the first winding region between the first winding region and the inner body, and wherein the cable with the mounted plugs at both ends is insertable into the second winding region and out of the outlet opening through respective slots in the rotationally symmetrical winding element and the rotationally symmetrical outlet disc.

43. The winding unit of claim 30, further comprising:
a housing with openings for two ends of the cable.

44. The winding unit of claim 29, according to claim 1, wherein the outlet opening in the rotationally symmetrical outlet disc extends over an entire width of adjacent turns of the cable in the second winding region.

45. The winding unit of claim 29, further comprising:
at least one glide-out unit arranged in the outlet opening, wherein the at least one glide-out unit comprises at least a first roller.

46. The winding unit of claim 29, further comprising:
a guiding frame on an outer side of the outlet disc arranged in a region of the outlet opening, wherein the cable extends through the guiding frame,
wherein a guiding unit of the guide frame extending into the second winding region moves the guide frame through the helical guide in a slot upon rotation of the second winding region.

47. The winding unit of claim 29, further comprising:
a guiding frame on an outer side of the outlet disc arranged in a region of the outlet opening, wherein the cable extends through the guiding frame,
wherein the guiding frame has at least a second roller, wherein the at least second roller has a concave cross-section along a longitudinal direction of the at least one roller.

48. The winding unit of claim 29, further comprising:
a guiding frame on an outer side of the outlet disc arranged in a region of the outlet opening, wherein the cable extends through the guiding frame; and
a cover extending over the outlet opening and the guiding frame, wherein the guiding frame is displaceable in a guide of the cover.
